(19) United States
(12) Patent Application Publication
(10) Pub. No.: US 2006/0023758 A1
(43) Pub. Date: Feb. 2, 2006

(54) Laser material, laser system and methods

(75) Inventors: Pu Wang, Strathfield (AU); Peter Dekker, Avalon (AU); Justin L. Blows, Erskineville (AU); Judith M. Dawes, Epping (AU); James A. Piper, Pennant Hills (AU)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MACQUARIE RESEARCH LTD.

(21) Appl. No.: 11/017,345

(22) Filed: Dec. 20, 2004

(30) Foreign Application Priority Data
Feb. 11, 2000 (AU) PQ5554

(51) Int. Cl. H01S 3/10; H01S 3/16

(52) U.S. Cl. 372/22; 372/41

(57) ABSTRACT

A nonlinear Yb:YAB laser material is disclosed. The material is capable of generating fundamental o-polarized first wavelength laser light and frequency doubled e-polarized second wavelength laser light, the material being oriented for type 1 phase matching of the first wavelength laser light. Also disclosed is a laser system. The system comprises a pumping light source emitting a pumping beam of light, a laser cavity having an input coupler operatively disposed with respect to the light source so as to couple the pumping beam of light into the cavity, and a nonlinear Yb:YAB laser material capable of lasing in response to a pumping beam of light thereby generating fundamental o-polarized first wavelength laser light and frequency doubled e-polarized second wavelength laser light, the material being oriented for type 1 phase matching of the first wavelength laser light, the first wavelength laser light being in the range of 1020-1100 nm and the second wavelength laser light being in the range of 510-550 nm. The input coupler comprises a reflector to at least partially reflect the first wavelength laser light and the second wavelength laser light into the cavity, and the laser cavity further includes an output coupler for coupling and outputting at least the second wavelength laser light from the cavity as an output laser beam. Also disclosed are methods of providing an output laser beam and methods of using the beam.

This invention relates to a nonlinear Yb:YAB laser material, a laser system, a method for providing an output laser beam from the laser system and methods of using such an output laser beam.

### BACKGROUND ART

Nd³⁺ doped self-frequency-doubling (SFD) crystalline solid state lasers based on Nd³⁺:LiNbO₃ (Nd:LN) and Nd³⁺:YAl₃(BO₃)₄ (Nd:YAB), have been extensively studied since the first reports of their operation [1,2]. These lasers offer attractive simplicity for visible laser generation, but also suffer from a number of problems, largely associated with the active Nd³⁺ ions, such as low quantum efficiency, high quantum defect, reabsorption loss in green and particularly difficulties of growth of the nonlinear laser material. As a result, SFD solid state lasers have not met with significant practical success.

More recently, Yb³⁺ doped nonlinear crystalline materials have received attention as alternative SFD laser media. Yb³⁺ has no concentration quenching, no excited state absorption, and no visible reabsorption loss [3], as well as offering high quantum efficiency, low quantum defect and potentially broad gain bandwidth. SFD green output of 60 mW at 532 nm has very recently been reported by Montoya et. al [4], for Yb³⁺:LiNbO₃:MgO crystals pumped by a Ti:sapphire laser; SFD green output at low power (<1 mW) has also been observed for the nonlinear laser crystals Yb³⁺:YCa₄B₃O₁₀ (Yb:YCOB) [5], and Yb³⁺:GdCa₄B₃O₁₀ (Yb:GdCOB) [6].

A recent report detailed studies of growth and spectral properties [7] and highly efficient diode-pumped infrared laser operation [8, 9] of the new nonlinear laser crystal Yb³⁺:YAl₃(BO₃)₄ (referred to herein as “Yb:YAB”). Yb:YAB has the advantages of comparatively easy growth (i.e. compared with Nd:YAB), large range of doping concentration (at least up to 20 at. %) at good crystal optical quality, large nonlinear optical coefficient (d_{eff}>1.4 pm/V), long radiative lifetime (˜680 μs) and good absorption and fluorescence spectral properties. Maximum output power of 654 mW at 1040 nm has been obtained at an absorbed pump power-output power slope efficiency of 71%, for pumping by a fibre-coupled 976 nm diode [8, 9].

### OBJECTS OF INVENTION

Objects of the invention are to provide a nonlinear Yb:YAB laser material, a laser system, a method for providing an output laser beam from the laser system and methods of using such an output laser beam.

### DISCLOSURE OF INVENTION

According to one embodiment of the invention there is provided a nonlinear Yb:YAB laser material capable of generating fundamental o-polarized first wavelength laser light and frequency doubled e-polarized second wavelength laser light said material being oriented for type 1 phase matching of the first wavelength laser light.

According to another embodiment of this invention there is provided a laser system, said system comprising:
a) a pumping light source emitting a pumping beam of light;
b) a laser cavity having:
   (i) an input coupler operatively disposed with respect to the light source so as to couple the pumping beam of light into the cavity; and
   (ii) a nonlinear Yb:YAB laser material capable of lasing in response to a pumping beam of light thereby generating fundamental o-polarized first wavelength laser light and frequency doubled e-polarized second wavelength laser light, said material being oriented for type 1 phase matching of the first wavelength laser light, the first wavelength laser light being in the range of 1020-1100 nm and said second wavelength laser light being in the range of 510-550 nm;
   (iii) said input coupler comprising a reflector to at least partially reflect the first wavelength laser light and second wavelength laser light into the cavity; and
   (iv) the laser cavity further including an output coupler for coupling and outputting at least the second wavelength laser light from the laser cavity as an output laser beam.
      method of providing an output laser beam from a laser system, said method comprising:
a′) pumping a nonlinear Yb:YAB laser material capable of lasing in response to a pumping beam of light thereby generating fundamental o-polarized first wavelength laser light and frequency doubled e-polarized second wavelength laser light, said material being oriented for type 1 phase matching of the first wavelength laser light, the first wavelength laser light being in the range of 1020-1100 nm and said second wavelength laser light being in the range of 510-550 nm, with said pumping beam of light whereby the Yb:YAB laser material lases in response to the pumping beam thereby generating fundamental o-polarized first wavelength laser light and frequency doubled e-polarized second wavelength laser light, the first wavelength laser light being in the range of 1020-1100 nm and said second wavelength laser light being at or about one half the wavelength of the first wavelength laser light, the second wavelength laser light being in the range of 510-550 nm; and
b′) coupling and outputting at least the second wavelength laser light from the laser cavity as an output laser beam.

Thus one form of the laser system comprises:
a) a pumping light source emitting a pumping beam of light, typically o-polarised;
b) a laser cavity having:
   (i) an input coupler operatively disposed with respect to the light source so as to couple the pumping beam of light into the cavity; and
   (ii) a nonlinear Yb:YAB laser material, generally a Yb:YAB laser crystal, oriented for type 1 phase matching, the Yb:YAB laser material being material which lases in response to the pumping beam thereby generating fundamental o-polarized first wavelength laser light and frequency doubled e-polarized second wavelength laser light, said second wavelength laser light being at about one hall the wavelength of the first wavelength laser light, the second wavelength laser light being in the range of 510-550 nm;
   (iii) said input coupler comprising a reflector to at least partially reflect the first wavelength laser light and second wavelength laser light into the cavity;
   (iv) the laser cavity further including an output coupler for coupling and outputting at least the second wavelength laser light from the laser cavity as an output laser beam.

One form of the method of providing an output laser beam from a laser system comprises:
a′) pumping a nonlinear Yb:YAB laser material, generally a Yb:YAB laser crystal, oriented for type 1 phase matching, with a pumping beam of light, typically o-polarized, whereby the Yb:YAB laser material lases and generates fundamental o-polarized first wavelength laser light and frequency doubled e-polarized second wavelength laser light, said second wavelength laser light being at about one half the wavelength of the first wavelength laser light, the second wavelength laser light being in the range of 510-550 nm; and
b′) coupling and outputting at least the second wavelength from the laser cavity as an output laser beam.

The invention also includes a method of using laser light for displaying laser light on a selected area comprising illuminating the selected area with the output laser beam of the invention.

The pumping beam of light may be unpolarised or polarised. In one form of the invention the pumping beam of light and the first wavelength laser light are o-polarised and the second wavelength laser light is e-polarised. In another form of the invention the pumping beam of light is unpolarised, the first wavelength laser light is o-polarised and the second wavelength laser light is e-polarised.

The efficiency of power conversion of the pumping beam of light to the second wavelength laser light is typically in the range of 0.1-13%+.

The laser system of the invention may be in the form of discrete components or integral components or a combination of both.

One of the advantages of the laser system of the invention is that it is scalable to high power of pumping light (e.g. from 0.001 Watt up to 60 Watt of pumping light, 10 Watt up to 60 Watt). An example of a suitable pumping light source is a fibre-coupled InGaAs diode laser, power in the range 1 W-20 W, more typically 10-15 W (pumping power) will, in part, determine output power of the laser material), fibre diameter 400 μm, numerical aperture 0.16, operating at a frequency in the range 975 nm-980 nm or at 975 nm, 976 nm or 977 nm with a bandwidth in the range of 1-5 nm. The pumping light source may be in the form of a diode array. Associated with the array are means to operate the array in a continuous or pulsed manner or other variable manner depending on the required use of the resultant output laser beam (i.e. whether a continuous or pulsed or otherwise variable output laser beam is required) from the laser cavity.

The cavity may further include means to select and/or tune the wavelength of the output beam. Typically the means to tune is a quartz birefringent filter which is inserted into the cavity to tune the laser system. The means to select the wavelength of the output beam may be linked or coupled to the Yb:YAB laser material or may be separate from the Yb:YAB laser material.

The output coupler may be a highly reflecting output coupler. Typically an RoC coupler is used (coated HR at 1020-1100 nm). Typically an output RoC coupler having a radius of curvature in the range of 1-12 cm, more typically 1, 2.5, 5, 7.5 or 10 cm is used.

The Yb:YAB material may be cooled. Thus the laser system may include means for cooling the Yb:YAB material. The laser system may be (as cooled (e.g. air cooled). One means for cooling is a Peltier temperature controller. The Yb:YAB material may be cooled while it is being pumped with the pumping light. Typically the means for cooling is capable of cooling the Yb:YAB material to and maintaining the material at a temperature (during pumping of the laser material) in the range of −10° C. to 40° C., or −10° C. to 25° C., 0° C. to 25° C., typically 0° C. to 20° C., more typically 5 to 15° C., and even more typically 0° C., to 5° C. More typically the Yb:YAB material is cooled to and maintained at 0.2, 4.5, 8, 10, 12, 14, 15, 18, 20, 22, or 25° C.

The invention includes a method of using laser light for displaying laser light on a selected area comprising illuminating the selected area with the output laser beam of the invention.

The invention includes a method of using laser light for displaying laser light on a selected area comprising illuminating the selected area with the output laser beam of the invention.

The cavity of the laser system may be configured to operate within a narrow bandwidth or in a single axial mode.

The invention includes a nonlinear Yb:YAB laser material cut and oriented for type 1 phase matching of the first wavelength laser light. Typically the Yb:YAB laser material is a crystal that is cut and oriented for type 1 phase matching of the first wavelength laser light. Typically the Yb:YAB laser material is a crystal that is cut and oriented for type 1 phase matching of the first wavelength laser light at normal incidence (θ≈31°±5°, φ=0°). The Yb:YAB crystals may be grown by the high temperature flux method to yield comparatively large crystals with high optical quality (see reference [7]).

The first wavelength laser light is in the range of 1020-1100 nm. More typically the first wavelength laser light is in the range of 1040-1068 nm and the second wavelength laser light is in the range of 510-550 nm, typically 513-545.8 nm and more typically 520-534 nm. The second wavelength laser light may be tuned to specific wavelengths within these ranges if required e.g. 514 nm or 532 nm. The second wavelength laser light may be tuned to a bandwidth of 0.2 nm if required. The type 1 phase matching angle is in the range θ≈31°±5°, φ=0°, or θ≈31°±5°, φ=0°, or θ≈31°±3═, φ=0°, typically θ≈31°±2°, φ0°, more typically θ≈31°±1°, φ=0°and even more typically θ≈31°, φ=0°. Typically the type 1 phase matching angle is chosen for optimum operation of the laser system whereby the power output of the laser output beam is substantially optimum (however, the invention also includes a laser system and a method of providing an output laser beam from a laser system where the phase matching angle of the nonlinear Yb:YAB laser material oriented for type 1 phase matching, is non optimal). This will be dependent on the temperature range in which one operates the laser system. A type I phase matching angle of θ≈31°±2°, φ=0°, more typically θ≈31°±1°, φ=0° is typically chosen for an operating temperature range of 25° C.±25° C., more typically 25° C.±20° C. The amount of Yb doping in the Yb:YAB crystal is typically in the range 1-30 atom %, more typically 1-20 atom %, more usually 10±7 atom %, usually 10±5 atom %, even more usually 10±2 atom %. Typically, the amount of Yb doping in the Yb:YAB crystal is about 1, 2, 3, 3.5, 4, 4.5, 5, 5.5, 6, 6.5, 7, 7.5, 8, 8.5, 9, 10, 11, 12, 13, 14, 15, or 20 atom %. Typically the crystal is of the order of 1-6 mm long, more typically 2-4 mm and usually about 3-4 mm long. Typically the Yb:YAB crystal is antireflection coated for pump and laser wavelengths.

The laser system may be a laboratory (e.g. scientific or medical laboratory) or industrial scale. Alternatively, the laser system may be portable.

The invention includes a method of using laser light for monitoring blood comprising illuminating the blood with the output laser beam of the invention and monitoring any chances in the laser beam after it has interacted with the blood. The invention includes a method of using laser light for treating, detecting or diagnosing, a selected area requiring such diagnosis or treatment on or in a subject comprising illuminating the selected area with the output laser beam of the invention. Typically the method further comprises detecting the output laser beam after it has interacted with the subject. Typically the selected area is illuminated with the output laser beam having the second wavelength for a time and at a power level which is appropriate and effective for the diagnosis or therapeutically effective for the treatment. The output laser beam having the second wavelength may, depending on the application, be continuous, pulsed or otherwise variable. In the event that a pulsed output laser beam having the second wavelength is required for medical applications the pulses are typically in a range selected from the group consisting of 1 to 650, 1 to 600, 1 to 550, 1 to 500, 1 to 450, 1 to 400, 1 to 350, 1 to 250, 1 to 150, 1 to 100, 1 to 50, 1 to 25, 1 to 10, 1 to 5, 2 to 20, 2 to 10 and 5 to 10 milliseconds. For example, the pulsed output laser beam may be at a pulse rate selected from the group consisting of 1, 2, 3, 4, 5, 6, 7, 8, 9, 10, 11, 12, 13, 14, 15, 16, 17, 18, 19, 20, 25, 30, 35, 40, 45, and 50 milliseconds. The pulse rate is one selected as being suitable for the desired application. Examples of medical applications include dermatological applications, scalp applications and ophthalmic applications. For medical applications a typical pulse rate is 1, 5, 10, 15 or 20 milliseconds. The output laser beam having the second wavelength is particularly useful in medical applications (such as certain dermatological applications) requiring coagulation of blood because light of the second wavelength is absorbed by blood.

The subject may be a mammal or vertebrate or other animal or insect, or fish or tissue from such an animal. Typically the subject is a mammal or vertebrate which is a bovine, human, ovine, equine, caprine, Leporine, feline or canine vertebrate. Advantageously the vertebrate is a bovine, human, ovine, equine, caprine, Leporine, domestic fowl, feline or canine vertebrate.

The cavity may include at least one Q-switch such as an active Q-switch or a passive Q switch. An acousto-optical or electro-optical Q-switch can be used. Alternatively a cavity dumping configuration or other suitable means can be adopted (see “The Laser Guidebook” by Jeff Hecht, 2^{nd} edition, McGraw-Hill 1992, the whole content of which is incorporated by cross reference).

The cavity may include one or more etalons (e.g. (a) one or more free standing etalons: (b) an air etalon as shown in FIGS. 1 and 5; and/or (c) an integral etalon which is added on to the nonlinear Yb:YAB laser material oriented for type 1 phase matching, via deposition or other suitable means (e.g. a composite microchip with an etalon grown on it)).

The cavity may include at least one polariser (generally two polarisers).

In one form the cavity is configured by including means to mode lock the laser light such that the output laser beam is mode-locked Typically an active or passive mode locker is disposed in the cavity. It is particularly of advantage to mode lock the output laser beam to provide pulses in the range short pulses (≈10⁻³ seconds) to medium short (≈10⁻⁶-10⁻⁷ seconds, typically ≈10⁻⁶ seconds) to very short (≈10⁻⁹-10⁻¹⁰ seconds, typically ≈10⁻⁹ seconds) to ultrashort (≈10⁻¹²-10⁻¹³ seconds, typically ≈10⁻¹³ seconds).

### BRIEF DESCRIPTION OF DRAWINGS

FIG. 1: The setup diagram of self-frequency-doubling Yb:YAB laser experiment;

FIG. 2: (a) Infrared laser emission spectrum, with the etalon effect; and (b) green laser emission spectrum of Yb:YAB SFD lasers;

FIG. 3: Infrared and green output power as a function of incident pump power. The crystal mount temperature is 20° C.;

FIG. 4: Green output power as a function of wavelength tuned by a 1.32 mm-thick quartz birefringent filter (B. F.);

FIG. 5: Schematic diagram of a laser system of the invention; and

FIG. 6: Schematic diagram of an alternative laser system of the invention.

### BEST MODE AND OTHER MODES FOR CARRYING OUT INVENTION

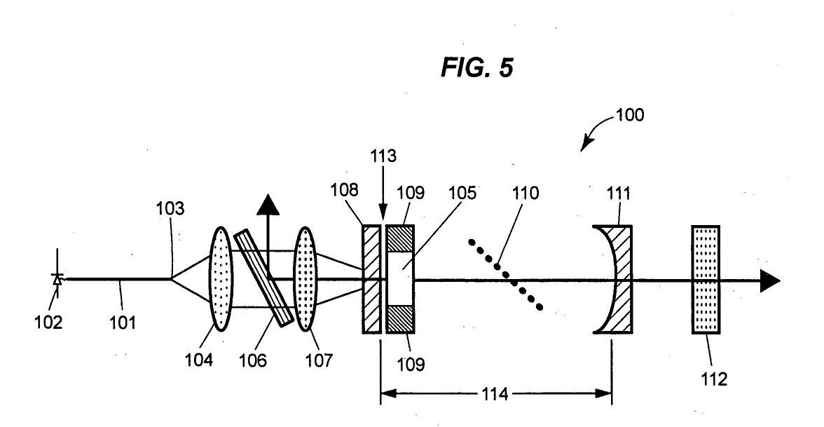

FIG. 5 depicts a laser system 100. System 100 comprises optical fibre 101 which is coupled to laser diode 102 (typically λ=967 nm±5 nm). In use, a pumping beam of light (typically λ≈976 nm) emerging from end 103 of optical fibre 101 (as an alternative to an optical fibre one could use a suitable combination of lenses or no lenses at all) is imaged onto 10 atom % Yb doped Yb:YAB crystal 105 to give an appropriate pump mode diameter of the pumping beam of light on crystal 105 via collimating lens 104, dichroic mirror 106, focus lens 107 and flat input mirror 108. Crystal 105 is cut with a type 1 phase matching angle (θ≈31°, φ=0°) for 1 μm obtained by calculation from the Sellmeier equations of Yb:YAB refractive indices and is typically polished to give optimum type 1 phase matching for normal incidence. Dichroic mirror 106 is typically highly reflecting (“HR”) in the range 510-550 nm, and highly transmitting for the frequency of the pumping beam of light (typically λ≈976 nm). A suitable combination of focal lengths for collimating lens 104 and focus lens 107 is f_{c}=3.1 mm for lens 104 and f_{f}=4.51 mm for lens 107, although it will be understood that other suitable combinations of f_{c} and f_{f} may be used as required. Flat input mirror 108 is highly transmitting for pump light (typically λ≈976 nm), reflecting for light in the range 510-550 nm and highly reflecting for fundamental first wavelength laser light (typically ≈1 μm, typically 1020 nm-1100 nm) generated when crystal 105 lases in response to pumping with a pumping beam of light. Crystal 105 is held in holder and temperature controller 109 (typically a copper holder and a Peltier temperature controller) to control and maintain the temperature of crystal 105 in use at a desired temperature or within a desired temperature range in use. Crystal 105 is located within the laser cavity 114 (which is defined by mirror 108 and output coupler 111 as depicted) in close proximity to mirror 108 so as to form thin air-space etalon 113. As depicted in FIG. 5 coupler 111 is a 10 cm radius of curvature output coupler which is highly transmitting in the range 510-550 nm and highly reflecting for fundamental first wavelength laser light generated when crystal 105 lases in response to pumping with a pumping beam of light. Cavity 114 includes birefringent filter 110 which may be used to tune cavity 114. Cavity 114 may also include an active or passive Q switch and/or an active or passive mode locker. Alternatively a Q switch may be located outside cavity 114 either between coupler 111 and filter 112 or after filter 112. Filter 112 is typically a band pass filter which transmits light in the range 510-550 nm and does not substantially transmit the fundamental first wavelength laser light.

In use, a pumping beam of light from diode 102 which is coupled to optical fibre 101 is imaged onto 10 atom % Yb doped Yb:YAB crystal 105 to give an appropriate pump mode diameter of the pumping beam of light on crystal 105 via collimating lens 104, dichroic mirror 106, focus lens 107 and flat input mirror 108. As a result the nonlinear Yb:YAB laser material oriented for type 1 phase matching, lases and generates fundamental o-polarized first wavelength laser light and frequency doubled e-polarized second wavelength laser light in cavity 114 the second wavelength laser light being at about one half the wavelength of the first wavelength laser light, the second wavelength laser light being in the range of 510-550 nm. At least the second wavelength laser light is coupled and outputted from cavity 114 as an output laser beam and is filtered by filter 112.

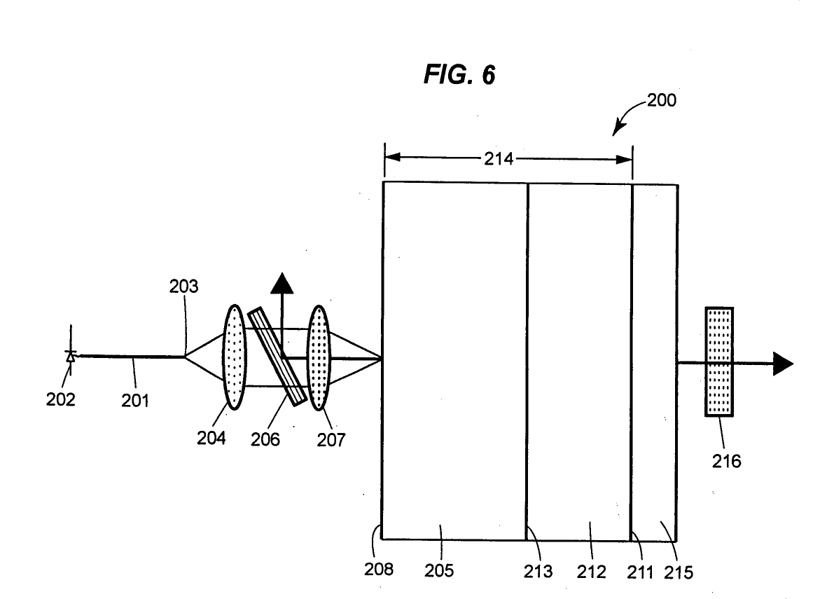

FIG. 6 depicts an alternative laser system 200. System 200 comprises optical fibre 201 which is coupled to laser diode 202 (typically λ≈976 nm±5 nm). In use, a pumping beam of light (typically λ≈976 nm) emerging from end 203 of optical fibre 201 (as an alternative to an optical fibre one could use a suitable combination of lenses or no lenses at all) is imaged (typically the pumping beam of light is o-polarised) onto a 10±5 atom % Yb doped Yb:YAB crystal 205 to give an appropriate pump mode diameter of the pumping beam of light on crystal 205 via collimating lens 204, dichroic mirror 206, focus lens 207 and flat input coating 208 (HR@≈1 μm, HT@976 nm, HR@510-550 nm). Crystal 205 is cut with a type 1 phase matching angle (θ≈31°, φ=0°) for 1 μm obtained by, calculation from the Sellmeier equations of Yb:YAB refractive indices and is typically polished to give optimum type-1 phase matching for normal incidence. Dichroic mirror 206 is typically highly reflecting (“HR”) in the range 510-550 nm, and highly transmitting for the frequency of the pumping beam of light (typically λ≈976 nm). A suitable combination of focal lengths for collimating lens 204 and focus lens 207 is f_{c}=3.1 mm for lens 204, and, f_{f}=4.51 mm for lens 207, although it will be understood that other suitable combinations of f_{c} and f_{f} may be used as required. Flat input coating 208 is highly transmitting for pump light (typically λ≈976 nm), reflecting for light in the range 510-550 nm and highly reflecting for fundamental first wavelength laser light generated when crystal 205 lases in response to pumping with a pumping beam of light. Crystal 205 may be held in a holder and temperature controller (not shown but typically a copper holder and a Peltier temperature controller) to control and maintain the temperature of crystal 205 in use at a desired temperature or within a desired temperature range in use. Crystal 205 is located within the laser cavity 214 (which is defined between coating 208 and output coupler 211 as depicted). As depicted in FIG. 6 coupler 211 is a coating on a layer of passive dielectric material 212. Coupler 211 is highly transmitting in the range 510-550 nm and highly reflecting for fundamental first wavelength laser light generated when crystal 105 lases in response to pumping with a pumping beam of light (typically≈1 μm. Cavity 214 includes partially reflecting coating 213 to tune cavity 214. An optional passive Q switch 215 is located outside cavity 214 on coating 211 (Cr⁴⁺:YAG is a possible passive Q switch material). An optional mode locking material may also be included in the structure if required. Filter 216 is typically a band pass filter which transmits light in the range 510-550 nm and does not substantially transmit the fundamental first wavelength laser light. The ratio of the length of crystal 205 to the length of material 212 should be chosen so as not to be an integer ratio.

In use, a pumping beam of light from laser diode 202 (eg frequency of pumping, beam of light of 975 or 976 nm) which is coupled to optical fibre 201 is imaged onto 10±5 atom % Yb doped Yb:YAB crystal 205 to give an appropriate pump mode diameter of the pumping beam of light on crystal 205 via collimating lens 204, dichroic mirror 206, focus lens 207 and flat input coating 208. As a result the nonlinear Yb:YAB laser material oriented for type 1 phase matching, lases and generates fundamental o-polarized first wavelength laser light (≈1020 nm-1100 nm) and frequency doubled e-polarized second wavelength laser light in cavity 214 the second wavelength laser light being at or about one hall the wavelength of the first wavelength laser light, the second wavelength laser light being in the range of 510-550 nm. At least the second wavelength laser light is coupled find outputted from cavity 214 (e.g. by an appropriate radius of curvature (RoC) output coupler) as an output laser beam and is filtered by filter 216.

### EXAMPLE

In this example, we report for the first time efficient CW self-frequency-doubling green laser operation of a type-1 phase-matched 3 mm-thick Yb:YAB crystal pumped by a 976 nm fibre-coupled diode. Tunable green output from 513-545.8 nm has also been demonstrated.

A 10 at. % Yb doped Yb:YAB crystal was roughly cut with a type-1 phase matching angle (θ≈31°, φ=0°) for 1 μm obtained by calculation from the Sellmeier equations of Yb:YAB refractive indices. The crystal was then carefully reoriented to give the strongest 532 nm green output power with the input of a pulsed 1064 nm Nd:YAG laser, and polished to give optimum type-1 phase matching for normal incidence. The crystal of dimension 3 mm×3 mm×3 mm was uncoated for a later laser experiment. The polarized absorption coefficients at 976 nm were 15 cm⁻¹ and 12 cm⁻¹ o-ray and e-ray, respectively with an absorption bandwidth 22 nm (FWHM).

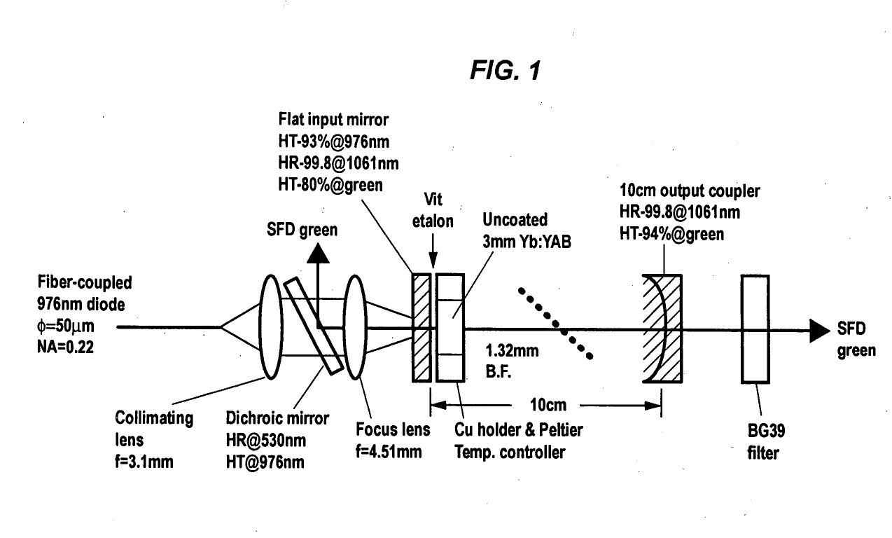

The pump and laser cavity configuration used in the present experiments is shown in FIG. 1. The 976 nm pump light from a 501 cm core-fiber-coupled 1.6 W laser diode was imaged through a flat cavity end-mirror onto the crystal using a f=3.1 mm collimating lens and a f=4.51 mm focusing lens to give a pump mode diameter of approximately 73 μm. The Yb:YAB crystal was held in a temperature controlled copper mount. The characteristics of the pump end-mirror coating are critical because a sharp edge between transmission at the pump wavelength and reflection at the laser wavelength (1010 nm-1100 nm) is required. The coating used for the present experiment had transmission 93% at 976 nm and reflection >99.8% from 1010-1100 nm, and also 80% transmission in the green (Lambda Research Optics). A 10 cm radius-of-curvature output coupler (transmission˜94% in the green and reflection >99.8% at 1010-1100 nm) was used to complete the Yb:YAB laser cavity, which teas of overall length approximately 10 cm. A 1.32 mm-thick single-plate quartz birefringent filter was inserted into cavity for experiments in tunability. The SFD green output power was measured at both ends of the cavity, at one end directly from the output coupler, and at other end, via a 45° dichroic mirror (HR at green and HT at 976 nm) placed between the collimating and focusing lenses. The green output powers quoted herein refer to the sum of SFD tureen obtained from both ends of the laser cavity (typically, output power from the coupler was 80% of the total power although this was quite dependent on cavity adjustment).

Because Yb³⁺:YAB is a quasi-four level system, it is expected that laser emission at the fundamental (IR) will be shifted to longer wavelength for low loss cavities due to the reduced reabsorption losses at longer wavelength. For example, the absorption coefficient at 1061 nm is less than 0.07 cm⁻¹; while the absorption coefficient at 1040 nm is approximately 0.28 cm⁻¹, for the Yb:YAB crystal used in the present experiment. For SFD operation in the present experiment where the output coupler used had a broad-band high reflective coating from 1010-1100 nm, the fundamental output wavelength was shifted to 1061 nm and operated with a bandwidth of up to 12 nm (note that for a 4% output coupler, the free-running wavelength of the fundamental was 1040 nm [9]).

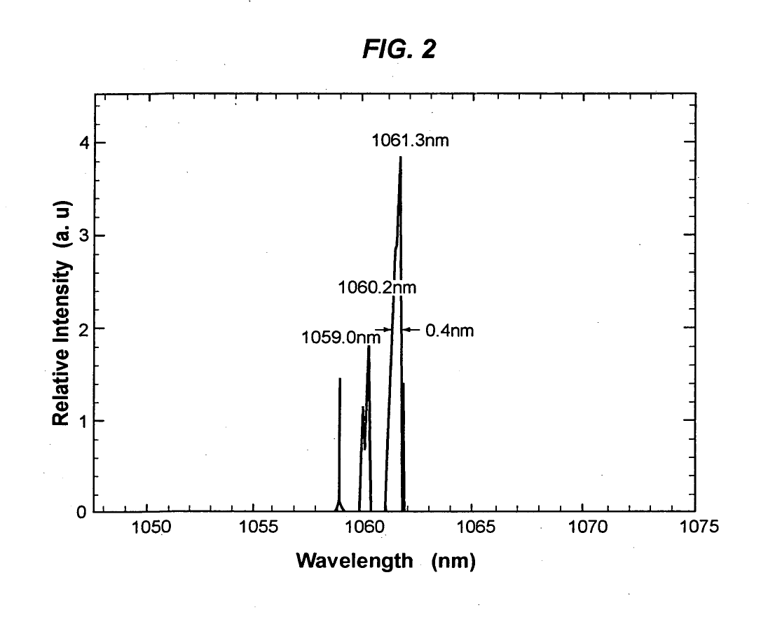

To narrow the bandwidth of fundamental laser emission, the distance and parallelism between the flat-input mirror and uncoated input face of the Yb:YAB crystal were adjusted to form a thin air-space etalon, as shown in FIG. 1. The resulting infrared and green laser emission spectra are shown in FIG. 2 (a) and (b) respectively, measured by an optical spectrum analyzer (Anritsu Co. MS9030A). Three infrared emission peaks were observed at 1061.3 nm, 1060.2 nm and 1059.0 nm with a bandwidth of 0.4 nm, and wavelength separation corresponding to a free spectral range of the etalon with spacing 510 μm. The main emission peak in the green was at 530.6 nm with a bandwidth of 0.2 nm at total output green power of 143 mW. It is anticipated that single-frequency operation can be achieved readily with appropriately designed intracavity etalons.

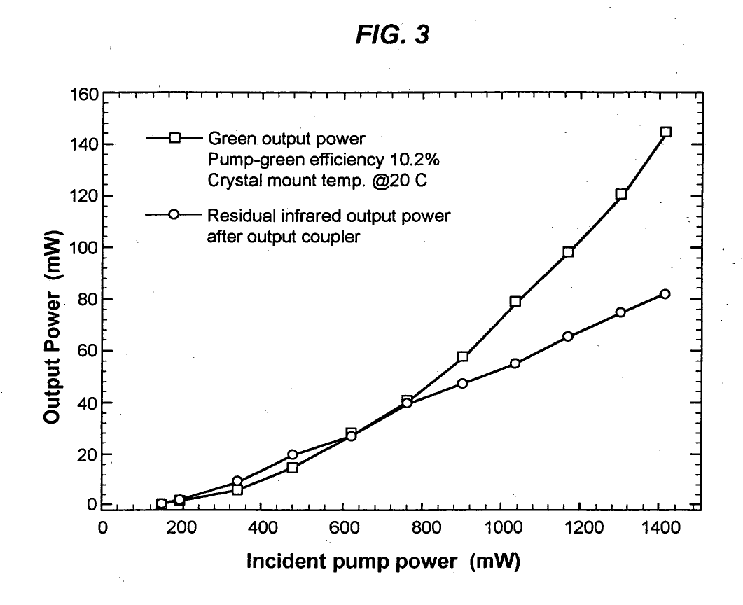

FIG. 3 shows measured SFD green and residual infrared output powers as a function of incident pump power. The crystal mount temperature was set at 20° C. using a Peltier temperature controller. The maximum incident pump power (unpolarized) onto the crystal was 1400 mW and more than 90% of the pump power was absorbed by the crystal. The pump power at threshold for both infrared and green was 150 mW. A maximum of 80 mW residual o-polarized infrared output was obtained after the output coupler. The maximum e-polarized SFD green output power was 143 mW, corresponding to an incident pump power-green output power conversion efficiency of 10.2%. The green output power increases quadratically with the incident pump power, indicating that the pump-green conversion efficiency can be increased further with increasing pump power.

Table 1 shows results of an investigation of the effects of the Yb:YAB crystal mount temperature on threshold pump power, maximum green output power and pump-green conversion efficiency.

TABLE 1
Temperature effect of the crystal on threshold pump
power. maximum green output power and pump-green conversion
efficiency at incident pump power 1400 mW

| Crystal mount | Threshold | Max green | Pump-green |
|---|---|---|---|
| Temperature | pump power | output power | efficiency |
| (° C.) | (mW) | (mW) | (%) |
| 4 | 219 | 143 | 10.2 |
| 6 | 190 | 146 | 10.4 |
| 8 | 150 | 160 | 11.3 |
| 10 | 150 | 155 | 11.1 |
| 12 | 141 | 152 | 10.8 |
| 14 | 141 | 150 | 10.7 |
| 16 | 141 | 149 | 10.6 |
| 18 | 141 | 146 | 10.4 |
| 20 | 150 | 143 | 10.2 |
| 22 | 150 | 141 | 10.0 |
| 24 | 150 | 139 | 9.9 |

The maximum green output power of 160 mW was obtained for a crystal mount temperature 8° C., giving an incident pump power-green output power conversion efficiency of 11.3% and electrical input to green power conversion efficiency of 3.9%. Note the threshold pump power increased quite rapidly and green output power decreased for crystal mount temperature below 8° C.; the reason for this is not clear at present.

TEM₀₀ mode for the green output at full power was obtained for laser cavity alignment adjusted to minimize the effects of beam walk-off. To the limit of the presently available pump power, we saw no evidence of the effects of thermally-induced distortion, including thermal lensing or optical damage of the Yb:YAB crystal.

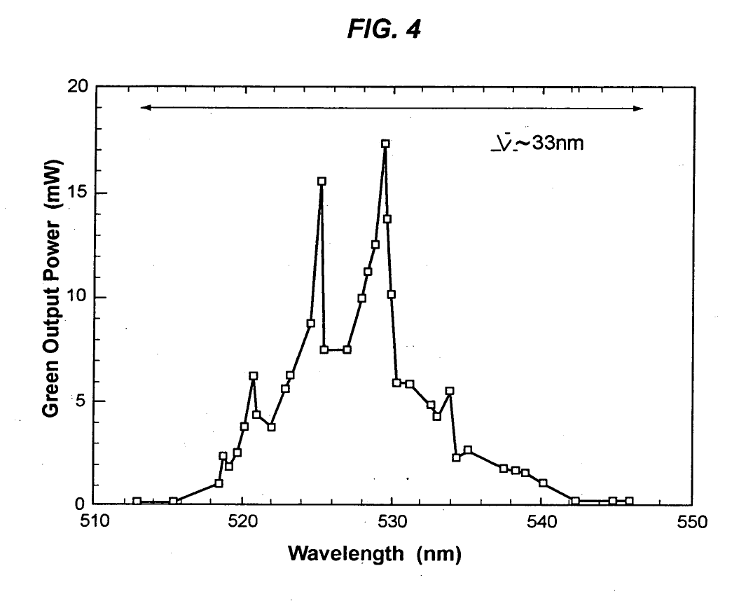

For investigation of wavelength tunable operation, a 1.32 mm-thick quartz single-plate birefringent filter was inserted into the cavity as indicated in FIG. 1. Green output power as a functional of laser wavelength is shown in FIG. 4. The total tunable range was, about 33 nm, from 513.0 nm to 545.8 nm with a bandwidth typically 0.4 nm and the maximum output power was 17.3 mW at 529.1 nm. The crystal was not adjusted for optimum phase matching angle during the tuning process, demonstrating that Yb:YAB has a broad spectral acceptance bandwidth.

The CW green output powers achieved in the present experiments are the highest reported for anti Yb³⁻ SFD materials by a considerable margin (factor of 3) and indeed compare favorably with the highest power reported for a diode-pumped Yb:YAG laser incorporating KTP as the intracavity frequency-doubling medium [11]. The visible tuning range of 33 nm achieved for Yb:YAB also exceeds that reported for the KTP/Yb:YAG configuration [12].

In summary, efficient CW self-frequency-doubled green laser output of 160 mW has been obtained from Yb:YAl₃(BO₃)₄ crystals, pumped by 1.4 W incident power from a fiber-coupled 976 nm laser diode. The incident pump power-green output power conversion efficiency is over 11.3% and electrical input-green conversion efficiency is 3.9%. Tunable green output from 513.0 nm-545.8 nm is also demonstrated, using a quartz birefringent filter.

In conclusion, we have demonstrated for the first time efficient CW self-frequency-doubling green laser output and wavelength tunability over 33 nm in the visible from diode-pumped Yb:YAB lasers. Relative ease of growth and favorable optical and thermal properties suggest that Yb:YAB has considerable potential as a practical laser material.

### REFERENCES

1. V. G. Dmitriev, E. V. Raevskii, N. M. Ruina, L. N. Rashkovichi, O. O. Silicheyand A. A. Fomichev, Sev. Tech. Phys. Lett., 5, 590 (1979).
2. L. M. Dorozhkin, I. I. Kuratev, N. I. Leonyuk, T. I. Timchenko and A. V. Shestakov, Sov. Tech. Phys. Lett. 7, 555 (1981).
3. P. Lacovara, H. K. Choi, C. A. Wang, R. L. Aggarwal, and T. Y. Fan, Opt. Lett. 16, 1089 (1991).
4. E. Montoya, J. Capmany, L. E. Bausa, T. Kellner, A. Diening, and G. Huber, Appl. Phys. Lett. 74, 3113 (1999).
5. D. A. Hammons, J. M. Eichenholz, Q. Ye, B. H. T. Chai, L. Shah, R. E. Peals, M. Richardson, and H. Qiu, Opt. Comm. 156, 327 (1998).
6. F. Mougel, K. Dardenne, G. Aka, A. Kahn-Harari, and D. Vivien, J. Opt. Soc. Am. B 16, 164 (1999).
7. P. Wang, J. M. Dawes, P. Dekker, D. S. Knowles, J. A. Piper, and B. S. Lu, J. Opt. Soc. Am. B 16, 63 (1999).
8. P. Wang, J. M. Dawes, P. Dekker, and J. A. Piper, OSA TOPS, Vol. 26, 614 (1999)
9. P. Wang, J. M. Dawes, P. Dekker, and J. A. Piper, Opt. Comm. 174, 467 (2000)
10. A. A. Lagatsky, N. V. Kuleshov, and V. P. Mikhailov, Opt. Comm. 165, 71 (1999)
11. T. Taira, J. Saikawa, E. Yamaguchi, T. Kobayashi, and R. L. Byer, OSA TOPS 19, 199 (1999)
12. J. Saikawa, S. Kurimura, I. Shoji, and T. Taira, OSA Technical digest of ASSL'2000. MB1

1. A nonlinear Yb:YAB laser material capable of generating fundamental o-polarized first wavelength laser light and frequency doubled e-polarized second wavelength laser light, said material being oriented for type 1 phase matching of the first wavelength laser light.

2. The laser material of claim 1 wherein the first wavelength laser light is in the range of 1020-1100 nm and the second wavelength laser light is in the range of 510-550 nm.

3. The laser material of claim 1 wherein the Yb:YAB laser material is oriented at a type 1 phase matching angle in the range selected from the group consisting of θ≈31°±5° and φ=0°, θ≈31 °±4° and φ=0°, θ≈31°±3° and φ=0°, θ≈31°±2° and φ=0°, and θ≈31°±1° and φ=0°.

4. The laser material of claim 1 wherein the Yb:YAB laser material is oriented at a type 1 phase matching angle of θ≈31° and φ=0°.

5. The laser material of claim 1 wherein Yb is present in the Yb:YAB laser material in an amount in the range of 1 to 30 atom %.

6. A laser system, said system comprising:
a) a pumping light source emitting a pumping beam of light;
b) a laser cavity having:
(i) an input coupler operatively disposed with respect to the light source so as to couple the pumping beam of light into the cavity; and
(ii) a nonlinear Yb:YAB laser material capable of lasing in response to a pumping beam of light thereby generating fundamental o-polarized first wavelength laser light and frequency doubled e-polarized second wavelength laser light, said material being oriented for type 1 phase matching of the first wavelength laser light, the first wavelength laser light being in the range of 1020-1100 nm and said second wavelength laser light being in the range of 510-550 nm;
(iii) said input coupler comprising a reflector to at least partially reflect the first wavelength laser light and second wavelength laser light into the cavity; and
(iv) the laser cavity further including an output coupler for coupling and outputting at least the second wavelength laser light from the laser cavity as an output laser beam.

7. The laser system of claim 6 wherein the Yb:YAB laser material is oriented at a type 1 phase matching angle in the range selected from the group consisting of θ≈31°±5° and φ=0°, θ≈31°±4° and φ=0°, θ≈31°±3° and φ=0°, θ≈31°±2° and φ=0°, and θ≈31°±1° and φ=0°

8. The laser system of claim 6 wherein the Yb:YAB laser material is oriented at a type 1 phase matching angle of θ≈31° and φ=0°.

9. The laser system of claim 6 further including means to tune the wavelength of the output beam.

10. The laser system of claim 6 further including means to select the wavelength of the output beam.

11. The laser system of claim 6 wherein the laser cavity has at least one etalon.

12. The laser system of claim 6 wherein Yb is present in the Yb:YAB laser material in an amount in the range of 1 to 30 atom %.

13. A method of providing an output laser beam from a laser system, said method comprising:
a) pumping a nonlinear Yb:YAB laser material capable of lasing in response to a pumping beam of light thereby generating fundamental o-polarized first wavelength laser light and frequency doubled e-polarized second wavelength laser light, said material being oriented for type 1 phase matching of the first wavelength laser light, the first wavelength laser tight being in the range of 1020-1100 nm and said second wavelength laser light being in the range of 510-550 nm, with said pumping beam of light whereby the Yb:YAB laser material lases in response to the pumping beam thereby generating fundamental o-polarized first wavelength laser light and frequency doubled e-polarized second wavelength laser light, the first wavelength laser light being in the range of 1020-1100 nm and said second wavelength laser light being at or about one half the wavelength of the first wavelength laser light, the second wavelength laser light being in the range of 510-550 nm; and
b) coupling and outputting at least the second wavelength laser light from the laser cavity as an output laser beam.

14. The laser material of claim 2 wherein the Yb:YAB laser material is oriented at a type 1 phase matching angle in the range selected from the group consisting of θ≈31°±5° and φ=0°, θ≈31°±4° and φ=0°, θ≈31°±3° and φ=0°, θ≈31 °±2° and φ=0°, and θ≈31°±1° and φ=0°.
